(19) United States
(12) Patent Application Publication
(10) Pub. No.: US 2025/0031058 A1
(43) Pub. Date: Jan. 23, 2025

(54) COMMUNICATION SYSTEM WITH COVERAGE ENHANCING DEVICE AND AIDING WIRELESS DEVICES

(71) Applicant: Sony Group Corporation, Tokyo (JP)

(72) Inventors: Fredrik RUSEK, Eslöv (SE); Olof ZANDER, Södra Sandby (SE); Jose FLORDELIS, Lund (SE); Kun ZHAO, Malmö (SE); Chaitanya TUMULA, Åkarp (SE); Erik BENGTSSON, Eslöv (SE)

(21) Appl. No.: 18/718,776

(22) PCT Filed: Dec. 7, 2022
(86) PCT No.: PCT/EP2022/084808

§ 371 Date: Jun. 11, 2024

(30) Foreign Application Priority Data
Dec. 23, 2021 (SE) 2151614-1

(51) Int. Cl. H04W 16/26; H04W 8/00

(52) U.S. Cl. CPC H04W 16/26; H04W 8/005

(57) ABSTRACT

A communication system is provided. The communication system comprises a network node. The communication system comprises one or more aiding wireless devices, such as a plurality of aiding wireless devices. The communication system may comprise a coverage enhancing device, CED, configured to redirect signals according to a predetermined spatial pattern. The network node may be configured to send, to the plurality of aiding WDs, a WD configuration message to configure the plurality of aiding WDs for contemporaneously sending discovery signals. In a first configuration of the CED, the CED may be configured to redirect a first set of discovery signals emitted by the plurality of aiding WDs according to a first predetermined spatial pattern.

### TECHNICAL FIELD

The present disclosure pertains to the field of wireless communications. The present disclosure relates to communication systems utilizing coverage enhancing devices, to methods of operation of the communication system and to methods of operation of components of the communication system.

### BACKGROUND

For initial access communications between network nodes and wireless devices (WDs), transmitted synchronisation signal block (SSB) beams are typically transmitted in a spatially wide area in order to discover WDs within range of the network node. However, the design of wide beams to cover the wide area may be difficult to achieve, as the network node may be restricted to phase changes only. The network node may therefore be required to utilize beamforming to scan for WDs within range of the network node, which may be a time consuming and power intensive process.

For example, consider a network node, a coverage enhancing device, CED, and a WD. Let α and β denote the spherical angles of the network node and WD, respectively, in relation to the CED. Then, the gain (up to a normalizing constant accounting for path losses and a phase rotation) between the network node and the WD may be given by A(β, α)=s^{T}(β)Cs(α), where s(θ) is an M×1 steering vector associated to θ, and C, which is a configuration of the coverage enhancing device, is a diagonal matrix whose diagonal contains complex exponentials representing phase delays per coverage enhancing device antenna.

During initial access, it can be advantageous to have a configuration C so that a wide beam is obtained. In view of A(β, α), a wide beam may mean that A(β, α) is “large for a wide range of α and β”. This may not be easy to achieve when the configuration C is restricted to phase changes only. The consequence of using a narrow beam may be that the CED must use many narrow beams to detect a WD, rendering large overhead.

### SUMMARY

Accordingly, there may be a need for communication systems that can reduce power consumption during the discovery of WDs within a range of the network node.

There may be a need for communication systems and related methods which may mitigate, alleviate, or address the existing shortcomings, for example by utilizing WDs connected to the network node for discovery of undiscovered WDs.

A communication system is provided. The communication system comprises a network node. The communication system comprises one or more aiding wireless devices, such as a plurality of aiding wireless devices. The communication system may comprise a coverage enhancing device, CED, configured to redirect signals according to a predetermined spatial pattern. The network node may be configured to send, to the plurality of aiding WDs, a WD configuration message to configure the plurality of aiding WDs for contemporaneously sending discovery signals. In a first configuration of the CED, the CED may be configured to redirect a first set of discovery signals emitted by the plurality of aiding WDs according to a first predetermined spatial pattern.

The communication system may advantageously reduce power consumption of the network node during discovery of discoverable WDs. For example, the communication system can leverage CEDs and/or aiding WDs to provide discovery signals for discovering undiscovered WDs, thereby reducing power consumption by the network node. Further, the communication system may advantageously have improved spectral efficiency. For example, a time for sweeping an area for undiscovered WDs may be shortened.

A method of operating a network node is provided. The method comprises transmitting, to a CED, a CED configuration message to configure the CED according to one or more configurations of the CED. The one or more configurations of the CED may allow the CED to redirect signals according to one or more spatial patterns. The CED configuration message may be indicative of a CED schedule for applying the one or more configurations of the CED. The method may comprise transmitting, to a plurality of aiding WDs, a WD configuration message to WDs configure the plurality of aiding for contemporaneously sending discovery signals. The WD configuration message may be indicative of discovery resources for transmission of the discovery signals. The CED schedule and the discovery resources may be aligned in a time domain and/or in a frequency domain, such that each respective discovery resource aligns with a respective configuration of the CED.

The method may advantageously reduce power consumption of the network node during discovery of discoverable WDs. For example, the method can leverage CEDs and/or aiding WDs to provide discovery signals for discovering undiscovered WDs, thereby reducing power consumption by the network node. Further, the method may advantageously have improved spectral efficiency. For example, a time for sweeping an area for undiscovered WDs may be shortened.

A method of operating a communication system may be provided. The method comprises transmitting, by a network node to a plurality of aiding WDs, a WD configuration message to configure the plurality of aiding WDs for contemporaneously sending discovery signals. The method may comprise transmitting, by the plurality of aiding WDs to a CED configured according to a first configuration, a first set of discovery signals. The method may comprise redirecting, by the CED configured according to the first configuration, the first set of discovery signals according to a first predetermined spatial pattern.

The method may advantageously reduce power consumption of the network node during discovery of discoverable WDs. For example, the method can leverage CEDs and/or aiding WDs to provide discovery signals for discovering undiscovered WDs, thereby reducing power consumption by the network node. Further, the method may advantageously have improved spectral efficiency. For example, a time for sweeping an area for undiscovered WDs may be shortened.

Also disclosed herein is a network node. The network node is configured to transmit, to a CED, a CED configuration message to configure the CED according to the one or more configurations of the CED, the one or more configurations of the CED allowing the CED to redirect signals according to one or more spatial patterns, wherein the CED configuration message is indicative of a CED schedule for applying the one or more configurations of the CED. The network node is configured to transmit, to a plurality of aiding WDs, a WD configuration message to configure the plurality of aiding WDs for contemporaneously sending discovery signals, wherein the WD configuration message is indicative of discovery resources for transmission of the discovery signals. The CED schedule and the discovery resources are aligned in a time domain, such that each respective discovery resource aligns with a respective configuration of the CED.

The network node may advantageously reduce power consumption during discovery of discoverable WDs. For example, the network node can leverage CEDs and/or aiding WDs to provide discovery signals for discovering undiscovered WDs, thereby reducing power consumption. Further, the network may advantageously have improved spectral efficiency. For example, a time for sweeping an area for undiscovered WDs may be shortened.

### BRIEF DESCRIPTION OF THE DRAWINGS

The above and other features and advantages of the present disclosure will become readily apparent to those skilled in the art by the following detailed description of examples thereof with reference to the attached drawings, in which:

FIGS. 1A-1B show example reflection signals of a coverage enhancing device.

FIGS. 2A-2B are example communication systems according to the disclosure.

FIGS. 3A-3B are example signalling diagrams for a communication system according to the disclosure.

FIG. 4 is an example reflection coverage enhancing device of a communication system according to the disclosure.

FIG. 5 is an example reflected power plot according to the disclosure.

FIGS. 6-11 are example coordinate transformation of signalling according to the disclosure.

FIG. 12 is a flow chart illustrating a method of operating a network node according to the disclosure.

FIGS. 13A-13D are a flow chart showing a method of operating a communication system according to the disclosure.

### DETAILED DESCRIPTION

Various example communication systems and methods are described hereinafter, with reference to the figures when relevant. It should be noted that the figures may or may not be drawn to scale. It should also be noted that the figures are only intended to facilitate the description of the examples. They are not intended as an exhaustive description of the disclosure or as a limitation on the scope of the disclosure. In addition, an illustrated example need not have all the aspects or advantages shown.

An aspect or an advantage described in conjunction with a particular example or embodiment is not necessarily limited to that example or embodiment and can be practiced in any other examples or embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

Disclosed herein are systems, and associated devices, for communication. Specifically, disclosed herein are communication systems. The disclosed communication systems can provide for reduced power consumption when discovering undiscovered wireless devices (WDs).

A communication system may be provided, the system comprising: a network node; a plurality of aiding wireless devices, WDs; and a coverage enhancing device, CED, configured to redirect signals according to a predetermined spatial pattern; wherein the network node is configured to send, to the plurality of aiding WDs, a WD configuration message to configure the plurality of aiding WDs for contemporaneously sending discovery signals; wherein, in a first configuration of the CED, the CED is configured to redirect a first set of discovery signals emitted by the plurality of aiding WDs according to a first predetermined spatial pattern.

A network node can be configured to send a WD configuration message to a plurality of aiding WDs, such that the plurality of aiding WDs may be instructed to contemporaneously send discovery signals. As used herein, an “aiding WD” of a communication system can be seen as a WD connected to the network node of the communication system, which can be configured to transmit discovery signals.

The plurality of aiding WDs may send a first set of discovery signals. For example, each aiding WD of the plurality of aiding WDs may send a respective discovery signal. As used herein, “first set of discovery signals” denotes a plurality of discovery signals contemporaneously sent by the plurality of aiding WDs at a first instant. The plurality of discovery signals of the first set of discovery signals can be redirected by a CED which is configured according to a first configuration of the CED. The first configuration of the CED redirects the first set of discovery signals according to a first predetermined spatial pattern.

As discussed herein, contemporaneous may be within a time period. For example, signals can be sent contemporaneously if they are sent while a CED is in a first configuration. A time period may be a time period that the CED is in a first configuration. Signals can be sent contemporaneously if they are sent while a CED is in a first configuration, etc. A time period may be a time period that the CED is in a second configuration, third configuration, etc. Contemporaneous may not be simultaneous. Contemporaneous may be simultaneous.

There is a dependency between the aiding WD positions, and the area(s) covered for each CED configuration, such as from each predetermined spatial pattern. The covered area may be clustered into multiple areas. The covered area may be formed by a union of multiple disjointed and/or non-contiguous areas.

The first predetermined spatial pattern may advantageously provide for a plurality of beams of discovery signals which covers one or more given spatial regions. Therefore, the first spatial pattern may be useful for discovery of electronic devices, such as WDs, located within the first predetermined spatial pattern. A spatial pattern, such as a first spatial pattern, may be associated with a spatial configuration of the reflection of signals off the CED. A spatial pattern, such as a first spatial pattern, may be associated with a spatial configuration of the reflection of signals off the CED and the aiding WD positions.

Since the first predetermined spatial pattern is generated by the redirection of the first set of discovery signals by the CED, such as by untargeted reflections, when the CED is configured according to the first configuration of the CED, the first configuration of the CED may advantageously be used to define the first predetermined spatial pattern.

The predetermined spatial pattern, such as the first predetermined spatial pattern and/or the second predetermined spatial pattern, can depend on both the CED configuration and the aiding WD locations. The predetermined spatial pattern, such as the first predetermined spatial pattern and/or the second predetermined spatial pattern, may be based on the configuration of the CED as well as the location of the aiding WDs. For example, moving location of the aiding WDs can change the predetermined spatial pattern. Further, adding and/or removing aiding WDs from a plurality of aiding WDs can change the predetermined spatial pattern. Changing a configuration of the CED can change the predetermined spatial pattern. For simplicity, only the CED configuration is discussed throughout, and is predetermined for the particular aiding WD locations. It will be understood that moving a location of the aiding WDs and/or adding and/or removing aiding WDs can change the predetermined spatial pattern.

Discovery signals may be SSB signals transmitted by the aiding WD, which may (like the traditional SSBs transmitted by a network node) comprise synchronization signals and an indication of UL resources for communicating with the network node (such as where and when to transmit signals in response to the SSB). Where and when can include at what time and/or frequency resources. The aiding WD may be configured by the network to transmit the discovery signals in dedicated resources, such as via a predetermined interface, which can use a Uu protocol. Discovery signals may be considered SSB-like signals. SSB signals may signals for 3GPP synchronization and/or setup.

The network node can restrict the aiding WDs to send the first set of discovery signals in specified directions. The specified directions may be the same directions as the directions that the aiding WDs use in communicating with the network node. Put another way, the first predetermined spatial pattern may be customized without a need for varying the directions along which the aiding WDs emit the discovery signals. Likewise, the generated first predetermined spatial pattern may provide for improved discovery capabilities in comparison with the use of narrow beams described above.

The network node disclosed herein may refer to a radio access network node operating in the radio access network, such as a base station, a 3GPP node, an evolved Node B (eNB), an access network node, a 5G radio access network node referred to as a gNB or a Non-Terrestrial Node (NTN), such as a satellite. An eNB or gNB may comprise one or more transmission point(s), TRP(s). Depending on the operating carrier frequency, a gNB may be operated with single or multiple beam transmission. Single beam may be referred as quasi-omni-directional transmission and typically used in lower frequencies (such as Frequency Range 1 in 5G New Radio). Multiple beams are typically used in Frequency Range 1 (FR1) for massive multiple-input and multiple-output (MiMo) base stations or Frequency Range 2 (FR2) (24 GHz and above) in order to compensate for path-loss. Multiple beams may consist of multiple narrow beams. A narrow beam typically has a higher gain than a single beam with omni-directional transmission.

The network node disclosed herein may be a core network node. A core network node disclosed herein may refer to a Location Server (LS), a Location Management Function (LMF) or an evolved Serving Mobile Location Center (e-SMLC). In some examples the core network node and the network node may be separate nodes or collocated nodes.

The coverage enhancing devices can be used for network management. The coverage enhancing devices can be used for beam and/or panel management. The coverage enhancing devices can be used for far-field propagation and/or near-field propagation. The coverage enhancing devices can utilize passive fixed array panels, active array panels, and/or intelligent surfaces to improve coverage and beamforming of signals.

The disclosed coverage enhancing devices can be one of a number of different types of devices, which can be used interchangeably herein. For example, the CEDs can be one or more of reconfigurable intelligent surfaces (RISs), repeater type devices, repeaters, intelligent surfaces, and reconfigurable reflective devices (RRDs). The CEDs can have one or more antennas, such as antenna panels, antenna elements, antenna inputs, antenna outputs, and/or unit cells for meta-surfaces. The CEDs can have one or more receivers, for example low-power receivers. The CEDs can have one or more transmitters, such as an active component that provides amplification to a signal.

As an example CED being a RIS, the RIS may, in certain circumstances though not in all circumstances, be compared to a metal plate, or a mirror, where azimuth and elevation can be tilted. Any input angle will have an associated output angle that depends on how it is tilted. Configuring it can mean that one such input-output angle pair is ensured, while the others are indirectly set as a result of the configuration of the targeted pair.

In one or more example communication systems, the signals disclosed herein can be one or more of: energy, transmission, wave energy, FR1 and FR2 signals, 5G signals, 6G signals, sub-6 GHz, electromagnetic energy, waves, electromagnetic plane waves, electromagnetic signals, plane signals, spherical waves, spherical signals, cylindrical waves, and cylindrical signals. As disclosed herein, waves and signals can be used interchangeably. Signals can include orbital angular momentum signals (OAM) and/or signals with any polarization properties. The particular type of signal is not limiting.

The CED can utilize passive components, such as passive fixed array panels, and active components. The passive components may be passive or semi-passive components.

Components of the disclosed CEDs systems, such as the active components and passive components, can be advantageous to redirect signals, such as to reflect signals. For example, the CEDs redirect an incoming signal from a given incoming direction to a given outgoing direction. Components of the CEDs can be used to redirect waves and/or signals in the mm wave spectrum. Further, the components of the CEDs can be configured to make redirections of signals which appear in-phase in a certain direction and/or area.

As disclosed herein, redirecting can include transmitting, reflecting, scattering, re-radiating, directing, and/or retransmitting a signal. The redirecting may include altering direction and/or polarization of a signal, and may further include one or more of: amplification, attenuation, termination, phase shifting, delaying, and spatial manipulation of a signal. Spatial manipulation may be, e.g., splitting into multiple components, widening, or in general applying any spatial filtering.

The wireless devices disclosed herein can be one of many types of wireless devices, for example one or more of: a user equipment, a user device, an electronic device, a computer, a tablet, a wireless device, a server, and a smartphone. The particular wireless device is not limiting. The wireless devices disclosed herein may be known as user equipment.

Advantageously, the network node can allocate resources for the aiding WDs to send discovery signals.

As disclosed herein, the terms signal, message, and data can be used interchangeably.

As used herein, the terms emitted, sent, and transmitted can be used interchangeably.

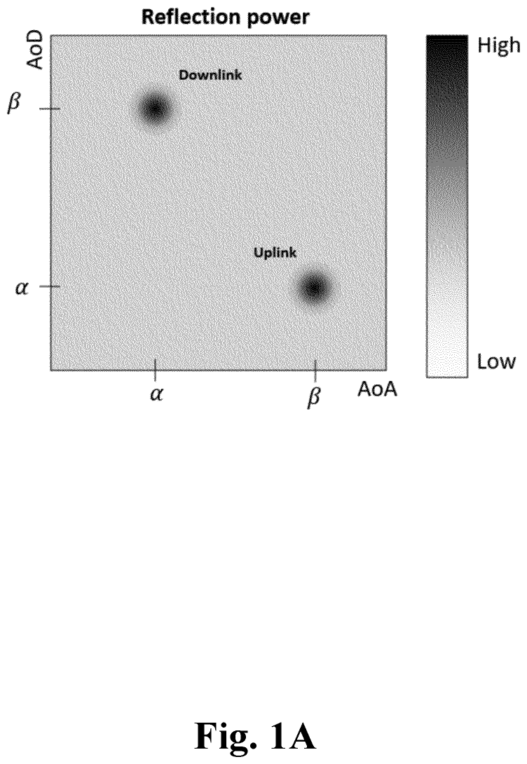

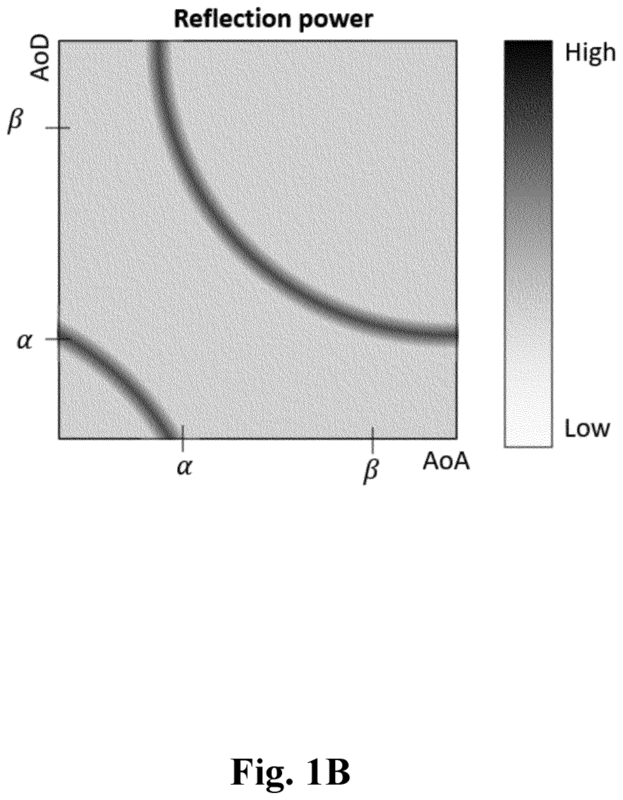

FIGS. 1A-1B illustrate reflection signals of a coverage enhancing device. In particular, FIGS. 1A-1B show reflection powers for angles of arrival (AoAs) and angles of departure (AoDs) of the signals. FIGS. 1A-1B may be understood to be a conceptual representation, as both the AoAs and the AoDs are spherical angles.

FIG. 1A illustrates a traditional understanding and intended function, that a configured CED only reflects signals in desired directions. According to this view, once a CED is configured, it only reflects signals between the two nodes it is intended to connect, such as a network node and a WD, via targeted, such as directed, reflections. A signal coming in from any other direction would not be reflected anywhere, but rather scattered diffusely. This is shown by two points in FIG. 1A, one for downlink, and one for uplink. In this idealistic scenario, any signal arriving at the CED with an AoA different from αor β would not be reflected.

FIG. 1B illustrates an updated understanding, according to which, for any AoA, a signal is reflected somewhere by the CED. According to this understanding, a CED reflects signals between the network node and a WD, but it also reflects signals with any other AoA. FIG. 1B illustrates a potential situation where interference may appear. For example, a CED can create untargeted, such as undirected, reflections. Put shortly, a CED configured to reflect a signal from A to B or vice versa (using incident AoAs α or β), via a targeted reflection, may in fact also reflect, equally well, a signal from any point C (not using an AoA of α or β), such as an untargeted reflection. The untargeted reflection destination, D, can be exactly calculated and may depend on A, B, and C. The direction of the untargeted reflection can be based on the configuration of the CED and the location of the aiding WDs.

Advantageously, the disclosed systems can leverage the untargeted reflections into an advantage by, for example, redirecting discovery signals into a spatially wide range in a short timeframe. For example, the untargeted reflections can be leveraged into an advantage for creating predetermined spatial pattern, such as the first predetermined spatial pattern and/or the second predetermined spatial pattern, that may play the role of a wide beam with the precision of a narrow beam, and thereby detect a new WD not currently connected, that is, a discoverable WD.

For example, a subset of WDs, known as aiding WDs, served by the CED can be configured to send discovery signals, all of which can be redirected into space via the CED via the untargeted reflections forming a predetermined spatial pattern. These redirected signals can improve the coverage of a network node in finding discoverable WDs, while advantageously reducing power output from the network node. For example, a large area can be covered quickly, such as extremely quickly, such as instantaneously, with the precision of a narrow beam. The precision of the signals can enable a network node to configure a CED with a pencil beam, thereby avoiding hierarchical beam sweeps.

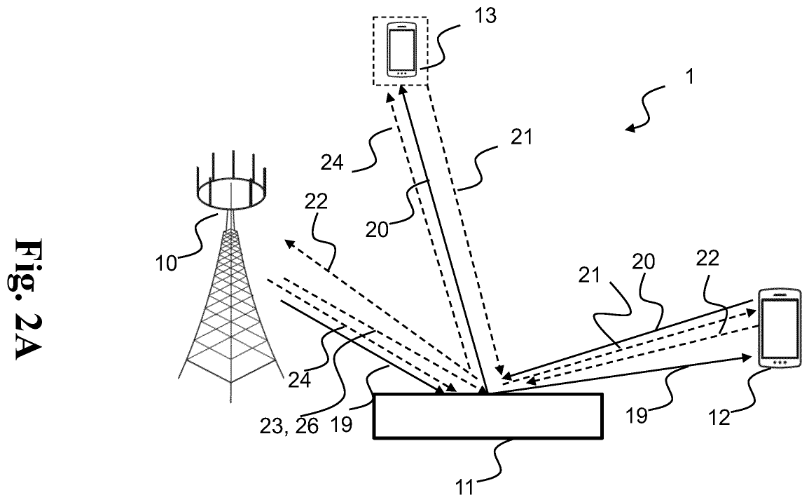

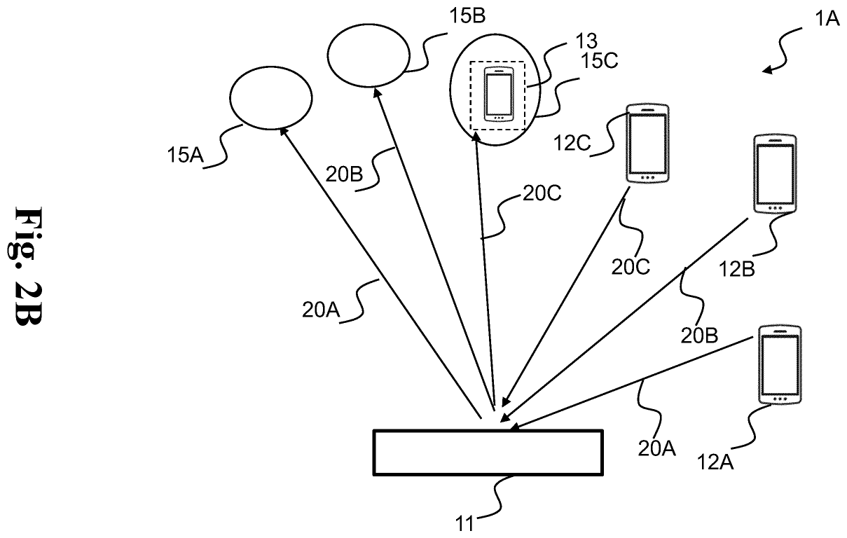

FIG. 2A is an example communication system 1 according to the disclosure. The communication system 1 comprises a network node 10, a coverage enhancing device, CED, 11 and a first aiding WD 12 which is one of a plurality of aiding WDs. The communication system can be advantageous for the discovery of a discoverable WD 13, such as by leveraging untargeted reflections from the CED 11. For convenience sake, only one aiding WD 12 is shown. Further discussion of a plurality of aiding WDs is shown in FIG. 2B.

A communication system 1 is provided. In one or more example communication systems, the communication system 1 comprises a network node 10. In one or more example communication systems, the communication system 1 comprises one or more aiding wireless devices, such as a plurality of aiding wireless devices. In one or more example communication systems, the communication system 1 may comprise a coverage enhancing device 11, CED, configured to redirect signals according to a predetermined spatial pattern. The predetermined spatial pattern may occur from untargeted reflections of the CED 11.

In one or more example communication systems, the network node 10 may be configured to send, to the plurality of aiding WDs, a WD configuration message 19 to configure the plurality of aiding WDs for contemporaneously sending discovery signals. In a first configuration of the CED 11, the CED 11 may be configured to redirect a first set of discovery signals emitted by the plurality of aiding WDs according to a first predetermined spatial pattern. For example, the redirection can occur via untargeted reflections of the CED. The first set of discovery signals may be redirected to different areas based on the incoming angle of each of the discovery signals of the first set of discovery signals.

The network node 10 is configured to send, to the plurality of aiding WDs, a WD configuration message 19 to configure the plurality of aiding WDs for contemporaneously sending of discovery signals. For example, as shown in FIG. 2A, the network node 10 is configured to send a WD configuration message 19 to configure the first aiding WD 12 to send first discovery signal 20.

In one or more example communication systems, the network node 10 is configured to send, to the CED, a CED configuration message 23 to configure the CED 11 according to the first configuration of the CED 11. The first configuration of the CED 11 may be considered a type B configuration.

A CED configuration message 23 may be a message which instructs the CED 11 to take a particular configuration. For example, the CED configuration message 23 can provide instructions to the CED 11 to be in a first configuration.

The plurality of aiding WDs, such as the first aiding WD 12, can each transmit a discovery signal, such as a first discovery signal 20 from the first aiding WD 12, to the CED 11. The CED 11 can then redirect the discovery signals, such as the first discover signal 20, to both a targeted reflection area as well as the untargeted reflection areas.

A first discoverable WD 13 can receive the first discovery signal 20 as redirected by the CED 11 from the first aiding WD 12. For example, the first discoverable WD 13 can be located within an untargeted reflection area of the CED 11 based on the direction of the first discovery signal 20 of the first aiding WD 12. Further, a plurality of discoverable WDs may receive one of the plurality of discovery signals from a plurality of aiding WDs.

In one or more example communication systems, when a first discoverable WD 13 receives the first discovery signal 20, the first discoverable WD 13 is configured to emit a first response signal 21.

As used herein, a discoverable WD 13 is understood to be a WD that is not connected, such as unconnected, with respect to a network node 10 of a communication system 1. For example, the communication system 1 may not know what CED configuration to use to obtain a link with an undiscovered WD. The discoverable WD 13 may however be connected to a network node different than the network node 10 of the communication system 1. The discoverable WD 13 may be a WD experiencing weak signal conditions or a high interference level, causing the discoverable WD 13 to not be able to detect SSBs from the network node 10.

When a first discoverable WD 13 is within the first predetermined spatial pattern, it may receive a first discovery signal 20. The emission of a first response signal 21 may be useful to detect a discovered discoverable WD 13.

As used herein, “first discovery signal” 20 describes a discovery signal from the first set of discovery signals. As used herein, “first discoverable WD” 13 refers to a discoverable WD to be discovered by means of a discovery signal from the first set of discovery signals. As used herein, “first response signal” 21 is construed as a response signal in response to a discovery signal from the first set of discovery signals.

In one or more example communication systems, the first discoverable WD 13 receives the first discovery signal 20 from the first aiding WD 12. Put another way, the first aiding WD 12 of this example communication system 1 emits the first discovery signal 20, which is redirected by the CED 11 according to the first predetermined spatial pattern towards the first discoverable WD 13, and receives the first response signal 21 from the first discoverable WD 13. The first response signal 21 may be redirected by the CED 11 in accordance with the first predetermined spatial pattern.

The first discoverable WD 13 may emit the first response signal 21 along the same direction as the direction along which the first discovery signal 20 was received by the first discoverable WD 13. If the CED 11 is reciprocal, the CED 11 will redirect the first response signal 21 in accordance with the first spatial pattern. Since the first configuration of the CED 11 gives rise to the first predetermined spatial pattern, the first configuration of a reciprocal CED 11 may allow the first aiding WD 12 of this example communication system 1 to emit the first discovery signal 20 and to receive the first response signal 21, as shown in FIG. 2A. This may allow for a faster and more efficient process of discovery and identification of discoverable WDs.

In one or more example communication systems, in response to a reception of the first response signal 21 by a first aiding WD 12 of the plurality of aiding WDs, the first aiding WD 12 is configured to send a first identification signal 22. The first identification signal 22 may be indicative of an identification of the first discoverable WD 13.

Advantageously, the plurality of aiding WDs, such as first aiding WD 12, may be part of the identification process of a discoverable WD, such as the first discoverable WD 13. In particular, when a first aiding WD 12 receives the first response signal 21, the first aiding WD 12 may send a first identification signal 22 which identifies the first discoverable WD 13.

As used herein, “first identification signal” is a signal sent by a first aiding WD in response to a first response signal.

In one or more example communication systems, the first aiding WD 12 is configured to send the first identification signal 22 to the network node 10. This may occur in a CED configuration different from the first CED configuration or the same as the first CED configuration. This may allow the network node 10 to be aware of the existence and angular position, which may include a location, of the first discoverable WD 13.

In FIG. 2A, the first aiding WD 12 can send a first identification signal 22 to the network node 10, the first identification signal 22 being indicative of an identification of the first discoverable WD 13. The network node 10 can be configured to determine a beam direction to the first discoverable WD 13, for example as the network node 10 is aware of the configuration of the CED 11 (in this case, the first configuration of the CED 11) and of the direction between the CED 11 and the first aiding WD 12.

In one or more example communication systems, the network node 10 is configured to, upon reception of the first identification signal 22, send, to the first discoverable WD 13, a first discoverable signal 24.

As used herein, a “discoverable signal” is a synchronization signal configured to synchronize a discoverable WD such that the discoverable WD may initiate its access to the communication system. The discoverable signal can be an SSB signal. As used herein, a “first discoverable signal” is a discoverable signal sent by the network node 10 upon reception of a first identification signal 22.

In one or more example communication systems, the network node 10 is configured to, upon reception of the first identification signal 22, send, to the CED 11, a first discoverable CED configuration message 26 to configure the CED 11 according to a first discoverable configuration of the CED 11. The first discoverable configuration of the CED 11 may allow signals emitted by the first discoverable WD 13 and the network node 10 to be redirected to one another. The CED 11 may change configuration based on the first discoverable CED configuration message 26. The CED 11 may not change configuration based on the first discoverable CED configuration message.

The first discoverable configuration of the CED 11 can configure the CED 11 such that a signal emitted by the network node 10 may be redirected by the CED 11 to the first discoverable WD 13, and a signal emitted by the first discoverable WD 13 may be redirected by the CED 11 to the network node 10. In other words, the first discoverable configuration of the CED 11 may advantageously configure the CED 11 to enable bidirectional communication between the network node 10 and the identified first discoverable WD 13.

As used herein, “first discoverable CED configuration message” is a CED configuration message sent by the network node 10 upon reception of a first identification signal 22. As used herein, “first discoverable configuration of the CED” is a configuration of the CED 11 applied upon reception of a first discoverable CED configuration message 26.

A discoverable configuration of the CED 11 may allow bidirectional sending of signals between the network node 10 and a discoverable WD 13 via redirections on the CED 11. This can be defined as a Type C configuration of the CED 11.

A configuration of the CED 11, such as the first and the second configurations of the CED 11, that allows redirection of discovery signals 20, sent by aiding WDs, such as first aiding WD 12, according to a spatial pattern may be referred to as a Type B configuration of the CED 11.

A configuration of the CED 11 associated with communications between aiding WDs, such as first aiding WD 12, and the network node via redirections on the CED 11 may be labelled as a Type A configuration of the CED 11.

In general, the set of CED configurations associated with the first CED configuration (type B) can be different to the set of CED configurations associated with “communication between the network node 10 and one or more WDs, such as first aiding WD 12 and/or first discoverable WD 13” (type A and C). The set of CED configurations associated with the first CED configuration may be one or more of: pencil beams, subject to beam splitting, and wide beam configurations.

In one or more example systems, the CED 11 may transmit a CED capability signal to the network node 10. The CED capability signal may be indicative of redirection by the CED 11. The network node 10 may be configured to send the first discoverable signal 24, the first discoverable CED configuration message 26 or both the first discoverable signal 24 and the first discoverable CED configuration message 26 at a suitable time, such as after an instant when a plurality of sets of discovery signals have been sent by the aiding WDs. Put another way, the first discoverable signal 24 and the first discoverable CED configuration message 26 need not be sent immediately upon reception of the first identification signal 22. A plurality of discoverable signals (such as a first discoverable signal 24 and a second discoverable signal), discoverable CED configuration messages (such as a first discoverable CED configuration message and a second discoverable CED configuration message) or both discoverable signals and discoverable CED configuration messages may be sent jointly at a suitable time, such as after the instant when the plurality of sets of discovery signals have been sent by the aiding WD.

In one or more example communication systems, the CED 11 can be configured to redirect the first discoverable signal 24 from the network node 10 to the first discoverable WD 13. Since the first discoverable configuration of the CED 11 may enable communication between the network node 10 and the identified first discoverable WD 13, the CED 11 may be advantageously relied upon to transmit the first discoverable signal 24.

The network node 10 can be configured to send, to the CED 11, a first discoverable CED configuration message 26 to configure the CED 11 according to a first discoverable configuration of the CED 11. The first discoverable configuration of the CED 11 allows signals emitted by the first discoverable WD 13 and the network node 10 to be redirected to one another. Put another way, the first discoverable configuration of the CED 11 allows to reflect network node signals, such as directions, in the direction of the first discoverable WD 13, such that normal initiation access can commence.

In one or more example communication systems, the first discoverable WD 13 is configured to, upon reception of the first discoverable signal 24, send, to the network node 10, a second response signal, such as a network node response signal.

In one or more example communication systems, the first discoverable WD 13 is configured to, upon reception of the first discoverable signal 24, send, to the network node 10, a random-access channel (RACH) signal. Sending a RACH signal may help the first discoverable 13 to follow the access process into the communication system 1.

In one or more example communication systems, the first response signal 21 that the discoverable WD 13 is configured to send is similar to a RACH response. The response signal 21 may typically be received by an aiding WD 12 instead of the network node 10. However, there may be a possibility that the first response signal 21 may be directly received at the network node 10. If so, this may not alter the disclosed communication system 1 as the network node 10 may still determine which aiding WD 12 transmitted the signal that the first discoverable WD 13 received.

In one or more example communication systems, in a second configuration of the CED 11, the CED 11 is configured to redirect a second set of discovery signals emitted by the plurality of aiding WDs according to a second predetermined spatial pattern. When a second discoverable WD receives a second discovery signal, the second discoverable WD may configured to emit a second response signal.

As used herein, “second set of discovery signals” denotes a plurality of discovery signals contemporaneously sent by the plurality of aiding WDs at a second instant, such as a second time period. The plurality of discovery signals of the second set of discovery signals are redirected by the CED 11 configured according to a second configuration of the CED 11. The second configuration of the CED 11 redirects the second set of discovery signals according to a second predetermined spatial pattern, which can provide a plurality of output beam directions for the discovery signals which covers a spatial region different from the first spatial region covered by the first predetermined spatial pattern. Therefore, the second spatial pattern may be useful for discovery of electronical devices, such as WDs, located within the second predetermined spatial pattern. This may advantageously increase the discovery and identification capabilities of the communication system without a need for additional dedicated components and without a significant increase in power consumption.

As used herein for the one or more example communication systems, “second discovery signal” describes a discovery signal from the second set of discovery signals. As used herein, “second discoverable WD” refers to a discoverable WD to be discovered by means of a discovery signal from the second set of discovery signals. As used herein, “second response signal” is construed as a response signal in response to a discovery signal from the second set of discovery signals.

As used herein, any other definition including the term “second” is similar to the corresponding definition including the term “first”, mutatis mutandis, that is, the term “second” refers to signals, messages, devices and any other elements taking part in a discovery or identification process of WDs when the process includes the aiding WDs sending the second set of discovery signals. The same applies to the terms “third”, “fourth”, “fifth”, “sixth”, “m th”, etc., up to Nth configurations of the CED 11 and Nth set of discovery signals sent by the plurality of aiding WDs.

As an example, a second aiding WD may be able to transmit the first discovery signal 20. The second aiding WD may be able to transmit a second discovery signal.

The example communication systems detailed below for the second configuration of the CED 11 may be advantageous for the same reasons as the corresponding example communication systems for the first configuration of the CED 11. The second configuration may allow for further undiscovered WDs to be discovered.

In one or more example communication systems, in response to a reception, by a second aiding WD, of the second response signal, the second aiding WD is configured to send a second identification signal. The second identification signal may be indicative of an identification of the second discoverable WD.

In one or more example communication systems, the second aiding WD is configured to send the second identification signal to the network node 10.

In one or more example communication systems, the network node 10 is configured to, upon reception of the second identification signal, send, to the second discoverable WD, a second discoverable signal.

In one or more example communication systems, the network node 10 is configured to, upon reception of the second identification signal, send, to the CED 11, a second discoverable CED configuration message to configure the CED 11 according to a second discoverable configuration of the CED 11. The second discoverable configuration of the CED 11 may allow signals emitted by the second discoverable WD and the network node to be redirected to one another.

In one or more example communication systems, the CED 11 is configured to redirect the second discoverable signal from the network node 10 to the second discoverable WD.

In one or more example communication systems, the first discoverable WD is configured to, upon reception of the second discoverable signal, send, to the network node, a RACH signal.

In one or more example communication systems, the second discoverable WD receives the second discovery signal from the second aiding WD. The second response signal may be redirected by the CED in accordance with the second predetermined spatial pattern.

In one or more example communication systems, the network node 10 is configured to send, to the CED 11, a second CED configuration message to configure the CED 11 according the second configuration of the CED 11, which can be a type B configurations.

In one or more example communication systems, the identification signal is indicative of the predetermined spatial pattern.

The identification signal may be sent by one of the plurality of aiding WDs. Therefore, the identification signal may contain an indication of the location of the one of the plurality of aiding WDs, such as the first aiding WD 12 or the second aiding WD, emitting the identification signal. When the identification signal is also indicative of a certain predetermined spatial pattern, and thus of the corresponding configuration of the CED 11, the identification signal may advantageously allow for the determination of the angular position of the corresponding discoverable WD, such as the first discoverable WD 13. This may improve the efficiency of the discovery and identification of WDs.

In one or more example communication systems, the CED 11 can comprise an array of antennas. A change in the configuration of the CED 11 may comprise a change in phase delay of the arrays of antennas.

Changing the phase delay of an array of antennas may enable a versatile manner of changing the configuration of the CED 11 to provide suitable predetermined spatial patterns.

In one or more example communication systems, the second predetermined spatial pattern covers a spatial region different from the first predetermined spatial pattern. This may enhance the discovery and identification capabilities of the communication system. In one or more example communication systems, the second predetermined spatial pattern can have a different association than the first predetermined spatial pattern. The second predetermined spatial pattern may overlap with the first predetermined spatial pattern. The second predetermined spatial pattern may not overlap with the first predetermined spatial pattern. The predetermined spatial pattern, such as the first predetermined spatial pattern and/or the second predetermined spatial pattern, may be based on an incoming signal. For example, the predetermined spatial pattern can be predetermined once the location of the network node 10 and/or plurality of aiding WDs are known.

In one or more example communication systems, in each of a plurality of configurations of the CED 11, the CED 11 is configured to redirect a set of discovery signals emitted by the plurality of aiding WDs according to a predetermined spatial pattern, the plurality of configurations of the CED 11 generating a plurality of predetermined spatial patterns. The plurality of spatial patterns may cover an entire area of a predefined spatial region.

As explained above for the first and the second configurations of the CED 11, the variation of the configuration of the CED 11 may produce a corresponding variation in the predetermined spatial pattern generated by the redirection of a set of discovery signals emitted by the plurality of aiding WDs. The communication system 1 may carry out a given number of variations of the predetermined spatial patterns until such plurality of predetermined spatial patterns cover an entire area of a predefined spatial region. This may lead to an efficient discovery of WDs located within the predefined spatial region.

In one or more example communication systems, the discovery signals are SSB signals.

Advantageously, the configuration of the CED 11 can be changed any number of times, and the communication system 1 can repeat the disclosed processes any number of times in order to cover a desired amount of direction, that is, a predefined spatial region. As different aiding WDs may send discovery signals to different areas based on their location with respect to the CED 11, and the untargeted reflections of the CED 11, a large area of space can be reviewed for determination of any discoverable WDs.

The communication system 1 can include K aiding WDs connected to the network node 10. A larger amount of aiding WDs, that is, a larger K, can provide for better discovery of discoverable WDs. The network node 10 can determine for the K aiding WDs to send a set of K discovery signals. Due to the untargeted reflection, such as redirection, performed by the CED 11, the K discovery signals can be reflected somewhere into space, forming a predetermined spatial pattern. If K is large, a large fraction of space will be reflected into. For example, the fraction can be larger than if only a single entity, such as the network node 10, would have transmitted discovery signals. If a large part of space is reflected into, this can be analogous to the creation of a wide beam. An undiscovered WD, such as first discoverable WD 13, may receive the discovery signal from one or more of the aiding WDs.

The K beams can correspond to spatial directions between the CED 11 and the K aiding WDs, which may be known to the network node 10. Therefore, the network node 10 may have awareness of the predetermined spatial pattern generated by the redirection of a set of discovery signals from the K aiding WDs on the CED 11 for a certain configuration C of the CED 11. It can therefore design a set of configurations C₁, C₂, . . . of the CED 11 in order to cover the entire predefined spatial region.

The network node 10 can be configured to allocate resources, such as time-frequency resources, in which a wide beam can be created. The network node 10 can request the K aiding WDs to send a set of discovery signals, such as an SSB signal and/or an SSB-like signal, towards the CED 11 in said resources, as explained above for the first aiding WD 12 at a first instant. The network node 10 can configure the CED 11 with a given configuration of the CED 11 in said resources. The K aiding WDs can be configured to transmit the discovery signals to the allocated resources.

In scenarios where the aiding WDs are close to the CED 11, which may be a common use case, the path loss between the aiding WDs and the CED 11 may be far less than the path loss between the network node 10 and the CED 11. Advantageously, an undiscovered WD may receive higher RSRP than if the network node 10 feeds the CED 11.

FIG. 2B illustrates a schematic of an example communication system 1A. The network node 10 and many of the signals from FIG. 2A have been removed for clarity.

As shown, the communication system 1A can include a plurality of aiding WDs (12A, 12B, 12C). The CED 11 can be configured to redirect a first set of discovery signals (20A, 20B, 20C) emitted by the plurality of aiding WDs (12A, 12B, 12C) according to a first predetermined spatial pattern. The first predetermined spatial pattern may redirect discovery signals of the first set of discovery signals (20A, 20B, 20C), into different areas according to the untargeted reflections of the CED 11.

For example, as shown discovery signal 20A from aiding WD 12A is redirected by the CED 11 into zone 15A based on untargeted reflections of the CED 11. As there is no discoverable WD in zone 15A, the aiding WD 12A will not receive a response signal. Similarly, discovery signal 20B from aiding WD 12B is redirected into zone 15B based on untargeted reflections of the CED 11, which also does not contain a discoverable WD.

Discovery signal 20C from aiding WD 12C is redirected by the CED 11 into zone 15C based on untargeted reflections of the CED 11. Zone 15C contains discoverable WD 13. Discoverable WD 13 can receive discovery signal 20C and then send a first response signal towards the CED 11 which will be redirected to aiding WD 12C.

The first set of discovery signals (20A, 20B, 20C) can be transmitted contemporaneously, which allows for a large coverage area to be achieved based on the untargeted reflections by the CED 11. Increasing the number of aiding WDs can increase the coverage area for each configuration of the CED 11.

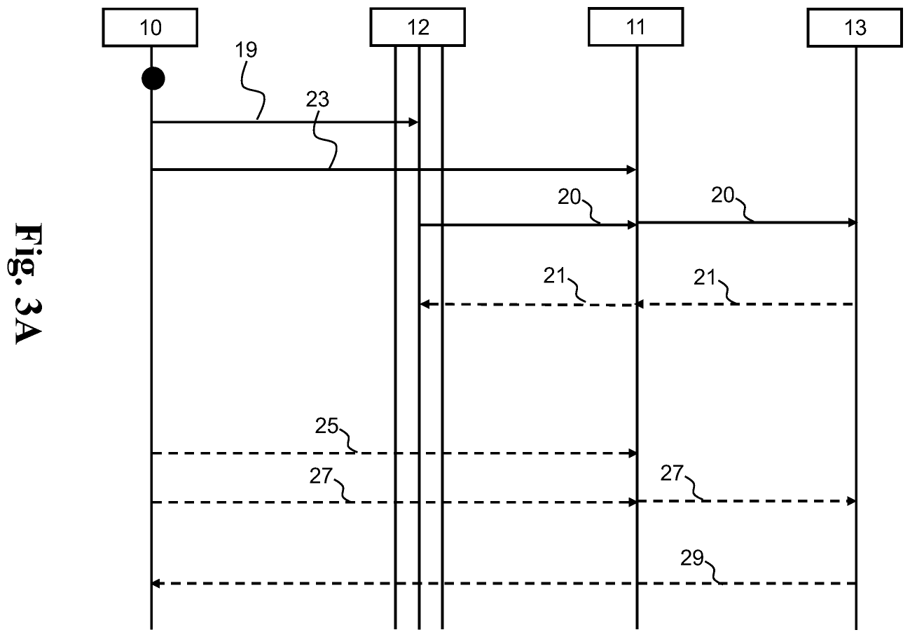

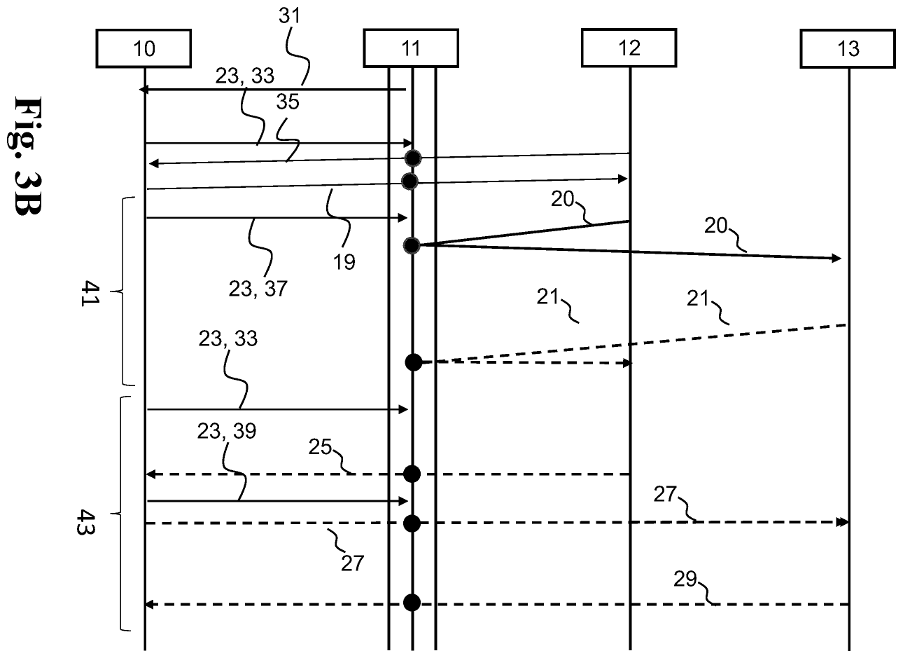

FIG. 3A is an example signaling diagram according to the disclosure for a communication system comprising a network node 11, K aiding WDs such as first aiding WD 12 and/or second aiding WD, a CED 11, in which first discoverable WD 13 is discovered and identified.

The discussion with respect to FIG. 3A is with respect to a single aiding WD and a single discoverable WD. It will be understood that a plurality of aiding WDs can be used to discover one or more discoverable WDs.

An assumption to be made with respect to FIG. 3A is that the network node 10, such as a gNB, is aware of the CED 11 to reach the K aiding WDs.

As shown, the network node 10 can send a WD configuration message 19. The network node 10 can transmit a WD configuration message 19 directly to the first aiding WD 12, or via the CED 11. Prior to the sending of the WD configuration message 19, the network node 10 can send a Type A CED configuration message to the CED 11 for Type A CED configuration. While only the first aiding WD 12 is shown, K number of aiding WDs can be used. The WD configuration message 19 can configure each of the aiding WDs to transmit a discovery signal, such as N discovery signals.

The network node 10 can also transmit a CED configuration message 23 to the CED 11. The CED configuration message 23 can configure the CED 11 into a first configuration, such as according to the N discovery signals.

The first aiding WD 12 can transmit a discovery signal 20 to the CED 11. The CED 11 can then redirect the discovery signal 20, which can then reach a first undiscovered WD 13.

The first undiscovered WD 13 can transmit a first response signal 21, which can be redirected by the CED 11 to the first aiding WD 12. The first aiding WD 12 can send the first identification signal 22 back to the network node 10.

In one or more example systems, prior to the sending of the discovery signal 20 and/or the first response signal 21, the network node 10 can send a Type B CED configuration message 37 to the CED 11 for Type B CED configuration.

In one or more example systems, after sending of the discovery signal 20 and/or the first response signal 21, the network node 10 can send the Type A CED configuration message 33 to the CED, such as before the first aiding WD 12 sends the first identification signal 22.

As the network node 10 is now aware of the first undiscovered WD 13, the network node 10 can send a second CED configuration message 25 to the CED 11 so the CED 11 is in a second configuration. Next, the network node 10 can send an SSB signal 27 to the CED, which is retransmitted to the first undiscovered WD 13. The first undiscovered WD 13 can send a second response signal 29, such as a RACH signal, to the CED 11, which can retransmit the second response signal 29, such as RACH signal, to the network node 10 for connection between the first undiscovered WD 13 and the network node 10.

In one or more example systems, prior to the sending of the SSB signal 27 and/or the second response signal 29 (such as RACH signal), the network node 10 can send a Type C CED configuration message to the CED 11 for Type C CED configuration.

In one or more example communication systems, the aiding WDs do not make sidelink communications with the one or more discoverable WDs.

FIG. 3B illustrates an example signaling diagram according to the disclosure for a communication system comprising a network node 11, K aiding WDs such as first aiding WD 12 and/or second aiding WD, a CED 11, in which first discoverable WD 13 is discovered and identified. FIG. 3B can include any and/or all of the features discussed with respect to FIG. 3A, and vice versa. In FIG. 3B, circles located with respect to CED 11 are illustrative of redirections by the CED 11.

As shown, the CED 11 may first send a CED capability signal 31 to the network node 10. The network node 10 can send a Type A CED configuration message 33 to the CED 11 for a Type A configuration. An aiding UE, such as first aiding UE 12 may send a UE capability signal 35 to the CED 11 which is redirected to the network node 10.

The network node 10 may send a type B CED configuration message 37 to the CED 11.

The network node 10 may send a WD configuration message 19 to the WD 12 associated with a first configuration of the CED (Type B).

The first aiding WD 12 can send a first discovery signal 20 to the CED, which can redirect the discovery signal 20 with an untargeted direction, which may be received by the first discoverable WD 13. In response, the first discoverable WD 13 may send a first response signal 21 to the CED 11, which will redirect the first response signal 21 to the first aiding WD 12.

The network node 10 can send a type A CED configuration message 33 to the CED 11.

The first aiding WD 12 can send the first identification signal 25 to the CED 11 which can redirect the first identification signal 25 to the network node 10.

The network node 10 can send a type C CED configuration message 39 to the CED 11. The network node 10 can send a second discovery signal 27 to the CED 11, which redirects the second directory signal 27 to the first discoverable WD 13. The first discoverable WD 13 can send a second response signal to the CED 11, which redirects the second response signal to the network node 10.

As shown in FIG. 3B, the signals bracketed by 41 and/or occur at least once, but can be performed any number of times.

Table 1 below illustrates example signals that have been discussed herein, as well as equivalent naming conventions. The types of signals discussed in Table 1 can be used throughout.

TABLE 1
Example Signal Mapping

| | 1 | 2 | 3 |
|---|---|---|---|
| Discovery Signal | SL discovery | SSB | SSB |
| from aiding WD | | | |
| Response signal | SL response | RACH and/or | RACH |
| | | MSG 1 | |
| Identification Signal | Identification | Identification | Identification |
| | Signal | Signal | Signal |
| First Discoverable | SSB | Msg 2 | SSB |
| Signal | | | |
| Second Response | RACH | Msg 3 | RACH |
| Signal | | | |

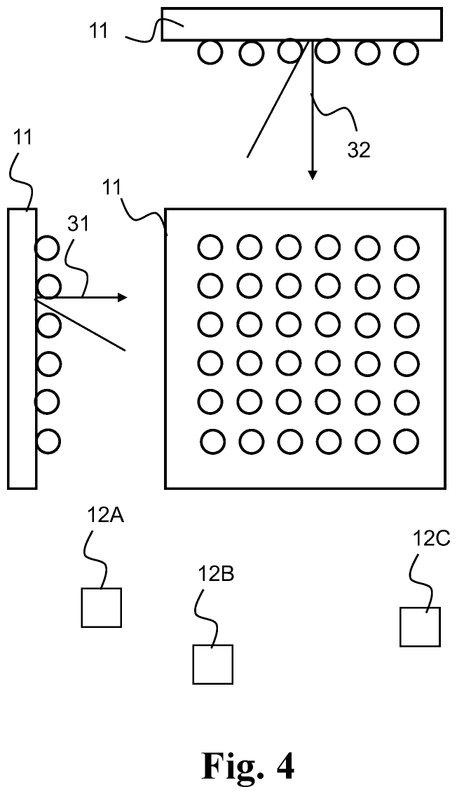

FIG. 4 illustrates an example CED 11 configured according to a configuration of the CED 11 in which, when all the aiding WDs, such as aiding WD 12A, aiding WD 12B, and aiding WD 12C, are located at elevations of 45 degrees or less, the elevation 31 of the discovery signals redirected by the CED is 45 degrees or less. A similar arrangement can be achieved for azimuth angles 32. Thus, a predetermined spatial pattern can be achieved.

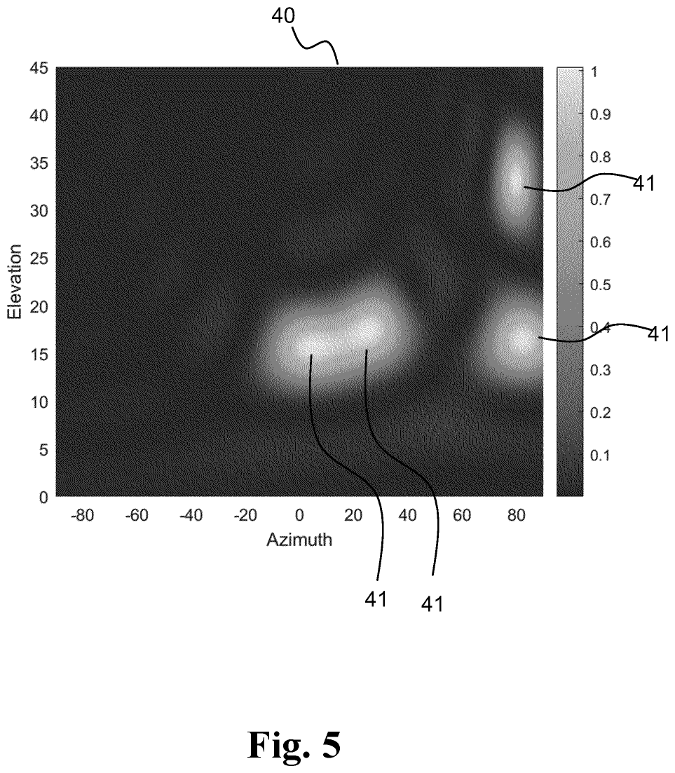

FIG. 5 is an example reflected power plot indicative of a first predetermined spatial pattern 40 generated by the redirection of discovery signals by a CED having a first configuration of the CED. In particular, FIG. 5 illustrates redirected power, in elevation 31 and azimuth 32, from a CED configured with the first configuration of the CED. First discovery signals received from the CED are sent from four aiding WDs, that is, K=4. Therefore, FIG. 5 shows a first predetermined spatial 40 pattern having four areas 41.

The first predetermined spatial pattern 40 illuminates a substantial part of the illustrated region. The large aera around 0 degrees azimuth is a superposition of discovery signals from two aiding WDs, that is, it is formed from two aeras 41.

By changing the configuration C of the CED, the predetermined spatial patterns move around the illustrated region. This can be performed by the network node, in an example or examples in which the network node is configured to send, to the CED, CED configuration messages to configure the CED according to a plurality of configurations of the CED.

Therefore, the CED can be configured with a sequence of configurations C of the CED, so that the plurality of spatial patterns cover the entire area of the illustrated region, which represents a predefined spatial region.

With only one input element emitting a discovery signal (for example, from the network node), there would only be one area in each predetermined spatial pattern. Therefore, a beam-widening of a factor K=4 can be created.

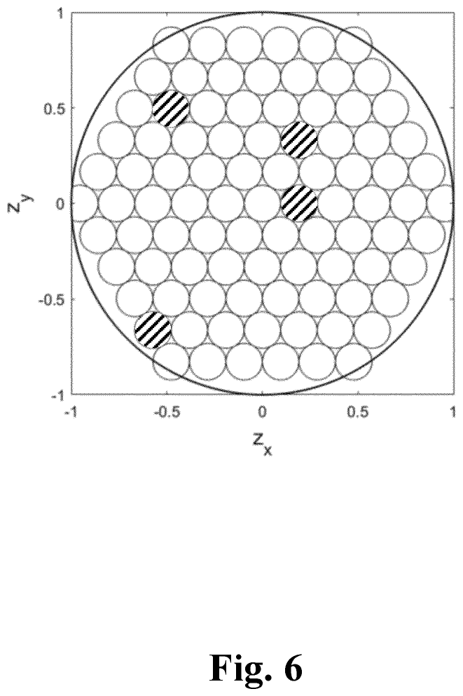

FIG. 6 to FIG. 11 depict a schematic example to provide for a structured way of constructing a sequence of configurations C of a CED, such as CED 11.

Assuming that the CED is equipped with N narrow beams that cover all directions in space, such as all directions of interest, each beam direction can be associated with an azimuth angle β_{a,n} and an elevation angle β_{e,n}.

For the sake of a simpler graphical representation, the following coordinate transformation, which is an injective map between (β_{a,n}, β_{e,n}) and (z_{x,n}, z_{y,n}), is made:

z_{x,n}=cos (β_{a,n}) sin (β_{e,n}) z_{y,n}=sin (β_{a,n}) sin (β_{e,n})

FIG. 6 shows a visualization of all N narrow beams in the new coordinate system. Each circle (not filled) represents one narrow beam. Four aiding WDs (that is, K=4) associated to four of these beams emit four first discovery signals to the hatched circles for a first configuration C₁ of the CED. In the new coordinate system (zₓ, z_{y}), no beam should lie outside the unit circle. The four discovery signals from the four aiding WDs form a first set of discovery signals, contemporaneously emitted at a first instant, such as at a first time period while the CED is in the first CED configuration. If the four discovery signals from the aiding WDs have coordinates {z_{x,n}, z_{y,n}}, then redirections may occur to the set {−z_{x,n},−z_{y,n}} to define a first predetermined spatial pattern. These are the hatched circles shown in FIG. 6.

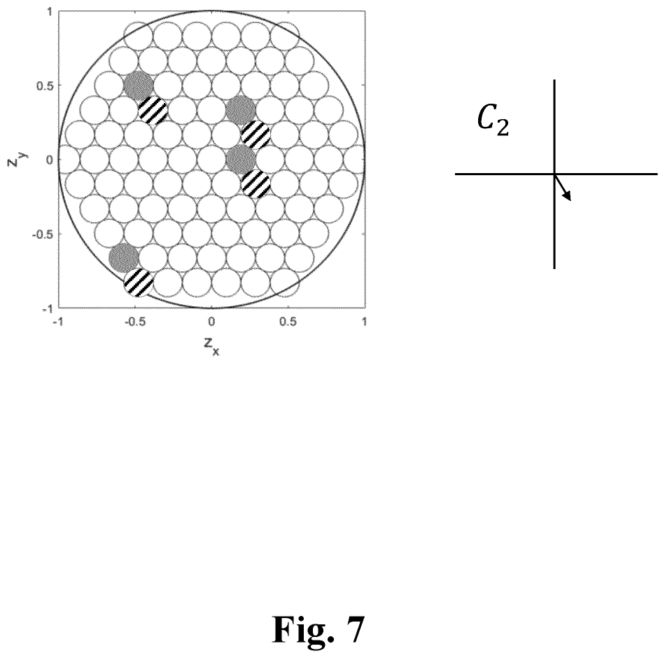

Then, the configuration of the CED is changed into a second configuration C₂, such as by selecting a pair of spherical coordinates between which the CED should redirect signals. The question is now to what directions a second set of discovery signals emitted by the four aiding WDs is redirected for the second configuration of the CED. The second configuration C₂ of the CED changes the redirections of the discovery signals in FIG. 6 by a simple translation; all solid circles are translated in the same way to form a second predetermined spatial pattern. By designing the pair of redirections directions from which the second configuration C₂ of the CED is constructed, an arbitrary translation can be obtained. For example, the second configuration C₂ of the CED can be chosen to obtain the second predetermined spatial pattern shown in FIG. 7. Specifically, the second configuration C₂ can be designed such that the reflection directions are translated by a certain offset that can be selected at will. In FIG. 7, the grey circles represent the first predetermined spatial pattern, whilst the hatched circles represent the second predetermined spatial pattern.

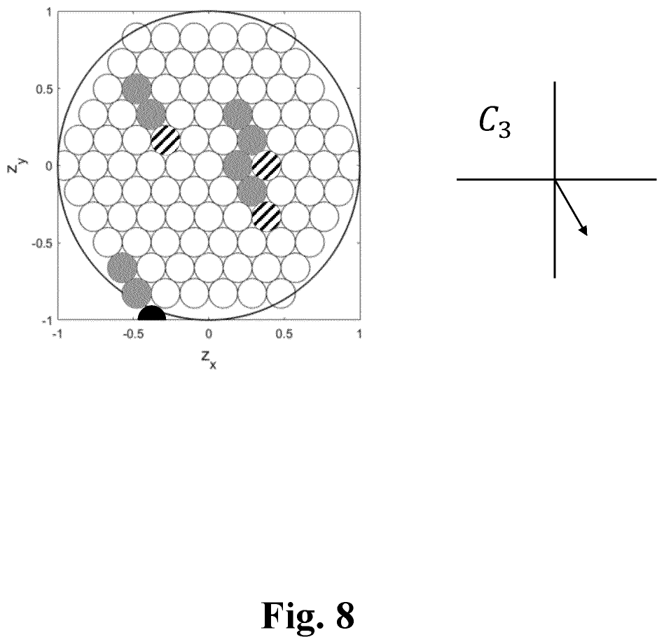

Next, the configuration of the CED is changed to a third configuration C₃ of the CED. In FIG. 8, the third configuration C₃ of the CED is selected such that the offset in the redirection of a third set of discovery signals is twice that of the second set of discovery signals for the second configuration C₂ of the CED, giving rise to a third predetermined spatial pattern. The third predetermined spatial pattern is illustrated with hatched circles, whereas the first and second predetermined spatial patterns are illustrated with grey circles. For that choice, a new phenomenon may occur, namely that a bottom-left black circle moves outside the unit circle representing a predefined spatial region. When this happens, there may be no reflection from the CED. The third discovery signal sent from the corresponding aiding WD is scattered by the CED when configured with the third configuration C₃.

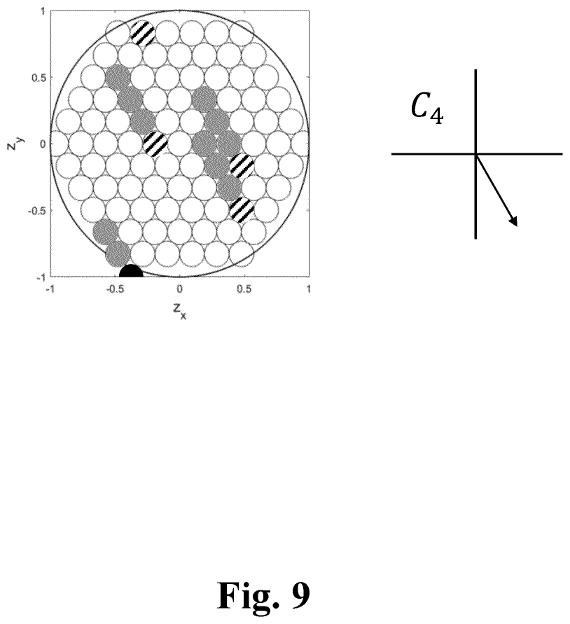

Subsequently, the configuration of the CED is changed to a fourth configuration C₄ of the CED, as shown in FIG. 9. The fourth configuration of the CED is selected so that the translation in the redirection of a fourth set of discovery signals is in the same direction as earlier, but longer. This gives rise to a fourth predetermined spatial pattern, represented with hatched circles. The first, second and third predetermined spatial patterns are illustrated with grey circles. A new effect occurs. The dashed circle which did not create any reflection, when the CED was configured with the third configuration, should move even further “southeast” in the predefined spatial region, which would result in the darkened circle outside of the unit circle represented in FIG. 9. However, as the redirections work in a modular fashion, the redirection of the corresponding fourth discovery signal ends up at the top of the figure as a hatched circle.

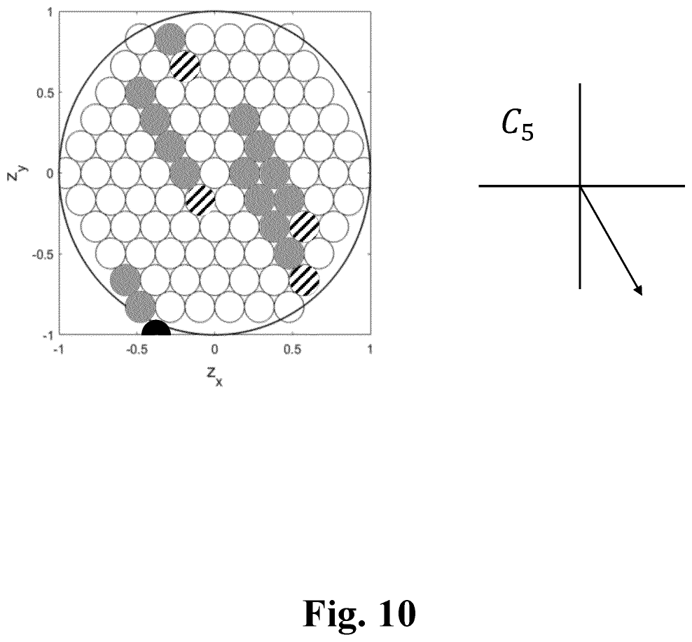

Then, the configuration of the CED is changed to a fifth configuration C₅ of the CED, depicted in FIG. 10, and the translation in the redirection of a fifth set of discovery signals is continued in the same direction, yielding a fifth predetermined spatial pattern. The fifth predetermined spatial pattern is illustrated with hatched circles, whereas the first, second, third and fourth predetermined spatial patterns are illustrated with grey circles. No new effects are shown in FIG. 10.

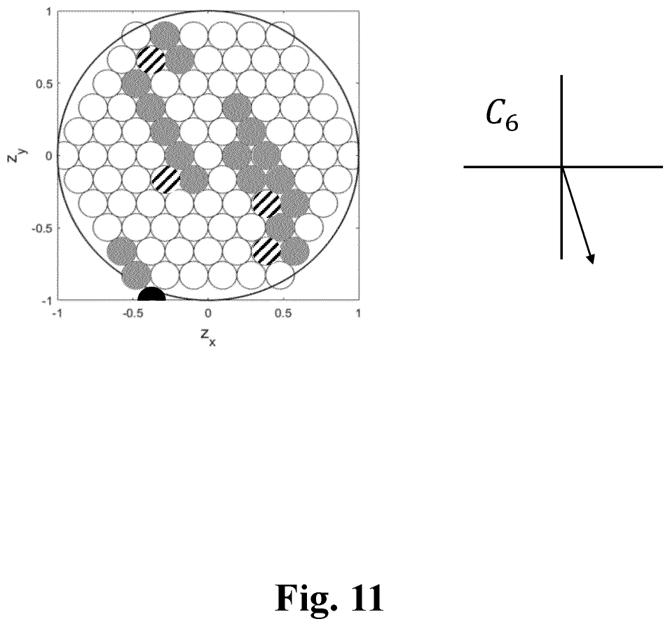

Finally, in FIG. 11, it is shown that the translation in the redirection of the discovery signals does not always have to extend in the same direction. FIG. 11 shows a sixth predetermined spatial pattern resulting from a sixth configuration C₆ of the CED. The sixth predetermined spatial pattern is illustrated with hatched circles, whereas the first, second, third, fourth and fifth predetermined spatial patterns are illustrated with grey circles.

It may be advantageous to have a number of configurations of the CED so that all of the circles become grey or hatched, thus allowing for the discovery of any discoverable WDs located within the predefined spatial region.

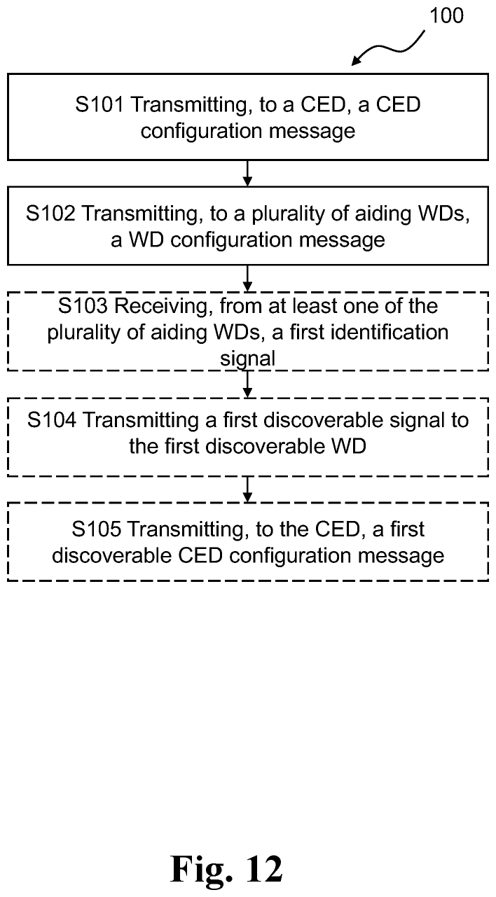

FIG. 12 shows a flow diagram of an example method 100, performed by a network node according to the disclosure, for operating the network node. For example, the method 100 can be performed by network node 10, which can provide signals to CED 11 and/or first aiding WD 12.

In one or more example methods, the method 100 comprises transmitting S101, to a CED, a CED configuration message to configure the CED according to the one or more configurations of the CED, the one or more configurations of the CED allowing the CED to redirect signals according to one or more spatial patterns. The CED configuration message may be indicative of a CED schedule for applying the one or more configurations of the CED. The one or more example methods 100 may comprise transmitting S102, to a plurality of aiding WDs, a WD configuration message to configure the plurality of aiding WDs for contemporaneously sending discovery signals. The WD configuration message may be indicative of discovery resources for transmission of the discovery signals. The CED schedule and the discovery resources may be aligned in a time domain, such that each respective discovery resource aligns with a respective configuration of the CED.

In one or more example methods, the method 100 can comprise receiving S103, from a first aiding WDs, a first identification signal, the first identification signal being indicative of an identification of a first discoverable WD.

In one or more example methods, the method 100 can comprise, upon reception of the first identification signal by the network node, transmitting S104, to the first discoverable WD, a first discoverable signal.

In one or more example methods, the method 100 can comprise, upon reception of the first identification signal, transmitting S105, to the CED, a first discoverable CED configuration message to configure the CED according to a first discoverable configuration of the CED, wherein the first discoverable configuration of the CED allows signals emitted by the first discoverable WD and the network node to be redirected to one another.

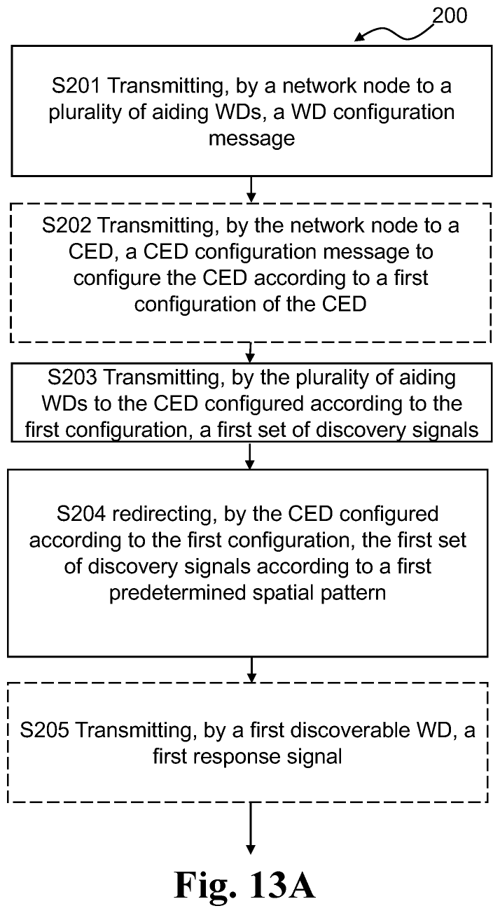

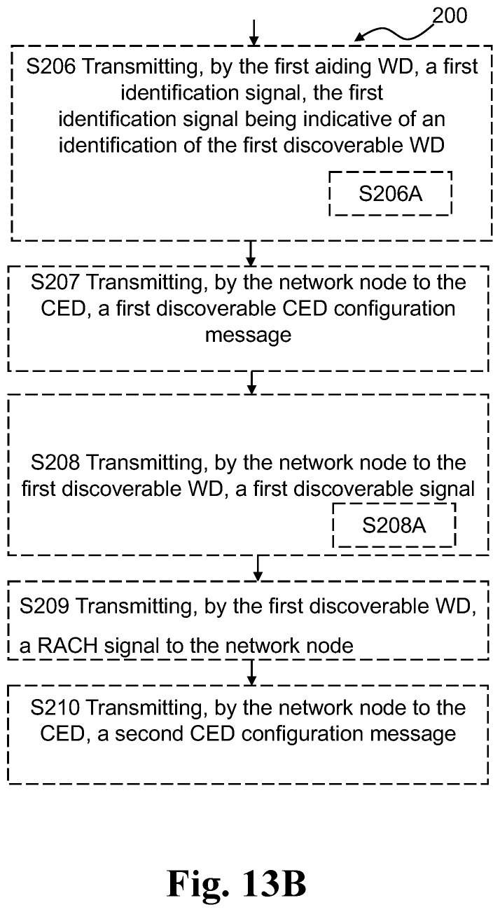

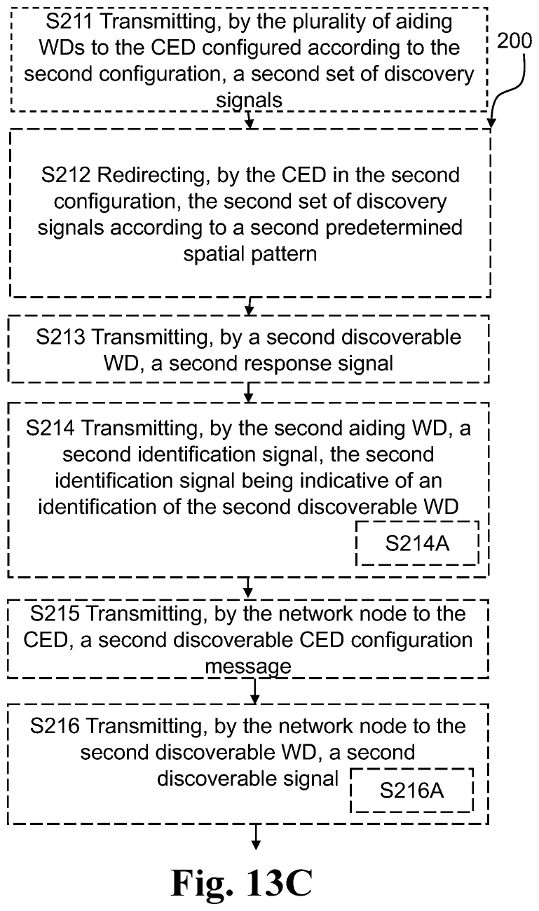

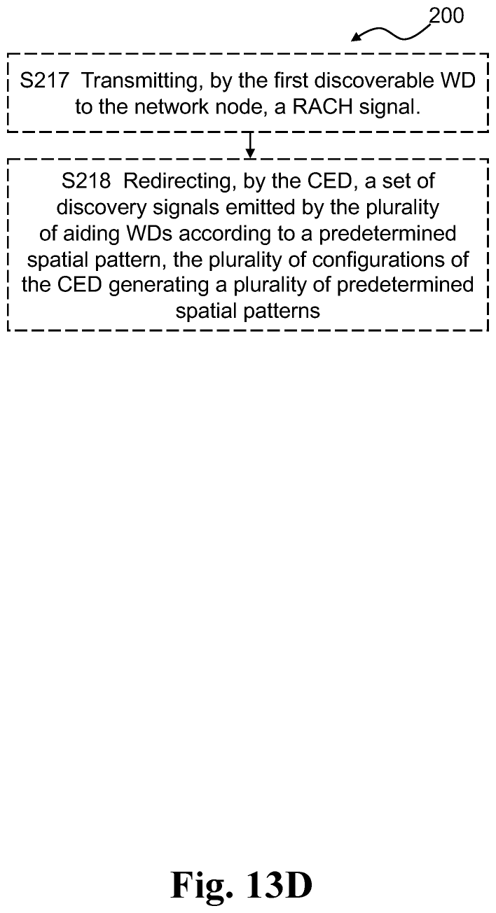

FIGS. 13A-D shows a flow diagram of an example method 200, performed by a communication system according to the disclosure, for operating the communication system. For example, the method 200 can be operated by one or more of the network node 10, CED 11, first aiding WD 12, and/or first discoverable WD 13.

In one or more example methods, the method 200 comprises transmitting S201, by a network node to a plurality of aiding WDs, a WD configuration message to configure the plurality of aiding WDs for contemporaneously sending discovery signals.

In one or more example methods, the method 200 comprises transmitting S202, by the network node to a CED, a CED configuration message to configure the CED according to a first configuration of the CED.

In one or more example methods, the method 200 comprises transmitting S203, by the plurality of aiding WDs to a CED configured according to a first configuration, a first set of discovery signals.

In one or more example methods, the method 200 comprises redirecting S204, by the CED configured according to the first configuration, the first set of discovery signals according to a first predetermined spatial pattern.

In one or more example methods, the method 200 comprises, when a first discoverable WD receives a first discovery signal, transmitting S205, by the first discoverable WD to a first aiding WD, a first response signal. In one or more example methods, the first discovery signal is emitted by a first aiding WD. In other words, the first discoverable WD may receive the first discovery signal from the first aiding WD.

In one or more example methods, the method 200 comprises, in response to a reception of the first response signal by the first aiding WD, transmitting S206, by the first aiding WD, a first identification signal, the first identification signal being indicative of an identification of the first discoverable WD.

In one or more example methods, transmitting S206 the first identification signal comprises transmitting S206A, by the first aiding WD to the network node, the first identification signal.

In one or more example methods, the method 200 comprises, upon reception of the first identification signal by the network node, transmitting S207, by the network node to the CED, a first discoverable CED configuration message to configure the CED according to a first discoverable configuration of the CED. The first discoverable configuration of the CED may allow signals emitted by the first discoverable WD and the network node to be redirected to one another.

In one or more example methods, the method 200 comprises, upon reception of the first identification signal by the network node, transmitting S208, by the network node to the first discoverable WD, a first discoverable signal.

In one or more example methods, transmitting S208 comprises redirecting S208A, by the CED, the first discoverable signal from the network node to the first discoverable WD.

In one or more example methods, the method 200 comprises, upon reception of the first discoverable signal by the first discoverable WD, transmitting S209, by the first discoverable WD to the network node, a RACH signal, such as a Msg3.

In one or more example methods, the method 200 comprises transmitting S210, by the network node to the CED, a second CED configuration message to configure the CED according to a second configuration of the CED.

In one or more example methods, the method 200 comprises transmitting S211, by the plurality of aiding WDs to the CED configured according to the second configuration, a second set of discovery signals.

In one or more example methods, the method 200 comprises redirecting S212, by the CED in the second configuration, the second set of discovery signals according to a second predetermined spatial pattern.

In one or more example methods, the method 200 comprises, when a second discoverable WD receives a second discovery signal, transmitting S213, by the second discoverable WD to a second aiding WD, a second response signal. In one or more example methods, the second discovery signal is emitted by a second aiding WD. In other words, the second discoverable WD may receive the second discovery signal from the second aiding WD.

In one or more example methods, the method 200 comprises, in response to a reception of the second response signal by the second aiding WD, transmitting S214, by the second aiding WD, a second identification signal, the second identification signal being indicative of an identification of the second discoverable WD.

In one or more example methods, transmitting S214 the second identification signal includes transmitting S214A the second identification signal by the second aiding WD to the network node.

In one or more example methods, the method 200 comprises, upon reception of the second identification signal by the network node, transmitting S215, by the network node to the CED, a second discoverable CED configuration message to configure the CED according to a second discoverable configuration of the CED. The second discoverable configuration of the CED may allow signals emitted by the second discoverable WD and the network node to be redirected to one another.

In one or more example methods, the method 200 comprises, upon reception of the second identification signal by the network node, transmitting S216, by the network node to the second discoverable WD, a second discoverable signal.

In one or more example methods, transmitting S216 comprises redirecting S216A, by the CED, the second discoverable signal from the network node to the second discoverable WD.

In one or more example methods, the method 200 comprises, upon reception of the second discoverable signal by the second discoverable WD, transmitting S217, by the second discoverable WD to the network node, a RACH signal.

In one or more example methods, the identification signals can be indicative of the predetermined spatial pattern.

In one or more example methods, the CED comprises an array of antennas. A change in the configuration of the CED can comprise a change in phase delay of the arrays of antennas.

In one or more example methods, the second predetermined spatial pattern covers a spatial region different from the first predetermined spatial pattern.

In one or more example methods, the method 200 comprises, in each of a plurality of configurations of the CED, redirecting S218, by the CED, a set of discovery signals emitted by the plurality of aiding WDs according to a predetermined spatial pattern, the plurality of configurations of the CED generating a plurality of predetermined spatial patterns. In one or more example methods, the plurality of spatial patterns can cover an entire area of a predefined spatial region.

In one or more example methods, the discovery signals can be SSB signals.

Prior to the method the CED may share a capability message with the network node.

The use of the terms “first”, “second”, “third” and “fourth”, “primary”, “secondary”, “tertiary” etc. does not imply any particular order. Moreover, the use of the terms “first”, “second”, “third” and “fourth”, “primary”, “secondary”, “tertiary” etc. does not denote any order or importance. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some circuitries or operations which are illustrated with a solid line and some circuitries or operations which are illustrated with a dashed line. Circuitries or operations which are comprised in a solid line are circuitries or operations which are comprised in the broadest example. Circuitries or operations which are comprised in a dashed line are examples which may be comprised in, or a part of, or are further circuitries or operations which may be taken in addition to circuitries or operations of the solid line examples. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

Examples of methods and products (communication systems) according to the disclosure are set out in the following items:

Item 1. A communication system comprising:
a network node;
a plurality of aiding wireless devices, WDs; and
a coverage enhancing device, CED, configured to redirect signals according to a predetermined spatial pattern;
wherein the network node is configured to send, to the plurality of aiding WDs, a WD configuration message to configure the plurality of aiding WDs for contemporaneously sending discovery signals;
wherein, in a first configuration of the CED, the CED is configured to redirect a first set of discovery signals emitted by the plurality of aiding WDs according to a first predetermined spatial pattern.

Item 2. The communication system according to Item 1, wherein the network node is configured to send, to the CED, a CED configuration message to configure the CED according to the first configuration of the CED.

Item 3. The communication system according to any one of Items 1 to 2, wherein, when a first discoverable WD receives a first discovery signal:
the first discoverable WD is configured to emit a first response signal.

Item 4. The communication system according to Item 3, wherein, in response to a reception of the first response signal by a first aiding WD of the plurality of aiding WDs, the first aiding WD is configured to send a first identification signal, the first identification signal being indicative of an identification of the first discoverable WD.

Item 5. The communication system according to Item 4, wherein the first aiding WD is configured to send the first identification signal to the network node.

Item 6. The communication system according to Item 5, wherein the network node is configured to, upon reception of the first identification signal, send a first discoverable signal to the first discoverable WD.

Item 7. The communication system according to any one of Items 5 to 6, wherein the network node is configured to, upon reception of the first identification signal, send, to the CED, a first discoverable CED configuration message to configure the CED according to a first discoverable configuration of the CED, wherein the first discoverable configuration of the CED allows signals emitted by the first discoverable WD and the network node to be redirected to one another.

Item 8. The communication system according to Items 6 and 7, wherein the CED is configured to redirect the first discoverable signal from the network node to the first discoverable WD.

Item 9. The communication system according to any one of Items 6 to 8, wherein the first discoverable WD is configured to, upon reception of the first discoverable signal, send a RACH signal to the network node.

Item 10. The communication system according to any one of Items 4 to 9, wherein the first discoverable WD receives the first discovery signal from the first aiding WD, and wherein the first response signal is redirected by the CED in accordance with the first predetermined spatial pattern.

Item 11. The communication system according to any one of Items 3 to 10, wherein, in a second configuration of the CED, the CED is configured to redirect a second set of discovery signals emitted by the plurality of aiding WDs according to a second predetermined spatial pattern; and wherein, when a second discoverable WD receives a second discovery signal:
the second discoverable WD is configured to emit a second response signal.

Item 12. The communication system according to Item 11, wherein, in response to a reception of the second response signal by a second aiding WD, the second aiding WD is configured to send a second identification signal, the second identification signal being indicative of an identification of the second discoverable WD.

Item 13. The communication system according to Item 12, wherein the second aiding WD is configured to send the second identification signal to the network node.

Item 14. The communication system according to Item 13, wherein the network node is configured to, upon reception of the second identification signal, send a second discoverable signal to the second discoverable WD.

Item 15. The communication system according to any one of Items 13 to 14, wherein the network node is configured to, upon reception of the second identification signal, send, to the CED, a second discoverable CED configuration message to configure the CED according to a second discoverable configuration of the CED, wherein the second discoverable configuration of the CED allows signals emitted by the second discoverable WD and the network node to be redirected to one another.

Item 16. The communication system according to Items 14 and 15, wherein the CED is configured to redirect the second discoverable signal from the network node to the second discoverable WD.

Item 17. The communication system according to any one of Items 14 to 16, wherein the first discoverable WD is configured to, upon reception of the second discoverable signal, send a RACH signal to the network node.

Item 18. The communication system according to any one of Items 12 to 17, wherein the second discoverable WD receives the second discovery signal from the second aiding WD, and wherein the second response signal is redirected by the CED in accordance with the second predetermined spatial pattern.

Item 19. The communication system according to any one of Items 11 to 18, wherein the network node is configured to send, to the CED, a second CED configuration message to configure the CED according the second configuration of the CED.

Item 20. The communication system according to any one of the preceding Items, wherein the identification signal is indicative of the predetermined spatial pattern.

Item 21. The communication system according to any one of the preceding Items, wherein the CED comprises an array of antennas, and wherein a change in the configuration of the CED comprises a change in phase delay of the arrays of antennas.

Item 22. The communication system according to any one of the preceding Items when depending on Item 11, wherein the second predetermined spatial pattern covers a spatial region different from the first predetermined spatial pattern.

Item 23. The communication system according to Item 23, wherein, in each of a plurality of configurations of the CED, the CED is configured to redirect a set of discovery signals emitted by the plurality of aiding WDs according to a predetermined spatial pattern, the plurality of configurations of the CED generating a plurality of predetermined spatial patterns; and
wherein the plurality of spatial patterns covers an entire area of a predefined spatial region.

Item 24. The communication system according to any one of the preceding Items, wherein the discovery signals are SSB signals.

Item 25. A method of operating a network node, the method comprising:
transmitting, to a CED, a CED configuration message to configure the CED according to the one or more configurations of the CED, the one or more configurations of the CED allowing the CED to redirect signals according to one or more spatial patterns, wherein the CED configuration message is indicative of a CED schedule for applying the one or more configurations of the CED; and
transmitting, to a plurality of aiding WDs, a WD configuration message to configure the plurality of aiding WDs for contemporaneously sending discovery signals, wherein the WD configuration message is indicative of discovery resources for transmission of the discovery signals;
wherein the CED schedule and the discovery resources are aligned in a time domain, such that each respective discovery resource aligns with a respective configuration of the CED.

Item 26. The method according to Item 25, further comprising:
receiving, from at least one of the plurality of aiding WDs, a first identification signal, the first identification signal being indicative of an identification of a first discoverable WD.

Item 27. The method according to Item 26, further comprising:
upon reception of the first identification signal by the network node, transmitting a first discoverable signal to the first discoverable WD.

Item 28. The method according to Item 26 or Item 27, further comprising:
upon reception of the first identification signal, transmitting, to the CED, a first discoverable CED configuration message to configure the CED according to a first discoverable configuration of the CED, wherein the first discoverable configuration of the CED allows signals emitted by the first discoverable WD and the network node to be redirected to one another.

Item 29. A method of operating a communication system, the method comprising:
transmitting, by a network node to a plurality of aiding WDs, a WD configuration message to configure the plurality of aiding WDs for contemporaneously sending discovery signals;
transmitting, by the plurality of aiding WDs, to a CED, configured according to a first configuration, a first set of discovery signals; and
redirecting, by the CED configured according to the first configuration, the first set of discover signals according to a first predetermined spatial pattern.

Item 30. The method according to Item 29, the method comprising:
transmitting, by the network node, to the CED, a CED configuration message to configure the CED according to the first configuration of the CED.

Item 31. The method according to Item 30, wherein, when a first discoverable WD receives a first discovery signal, the method comprises:
transmitting, by the first discoverable WD, a first response signal.

Item 32. The method according to Item 31, wherein, in response to a reception of the first response signal by a first aiding WD of the plurality of aiding WDs, the method comprises:
transmitting, by the first aiding WD, a first identification signal, the first identification signal being indicative of an identification of the first discoverable WD.

Item 33. The method according to Item 32, wherein transmitting the first identification signal comprises transmitting, by the first aiding WD to the network node, the first identification signal.

Item 34. The method according to Item 33, wherein upon reception of the first identification signal by the network node, the method comprises:
transmitting, by the network node to the first discoverable WD, a first discoverable signal to the first discoverable WD.

Item 35. The method according to Item 33 or Item 34, wherein upon reception of the first identification signal by the network node, the method comprises:
transmitting, by the network node to the CED, a first discoverable CED configuration message to configure the CED according to a first discoverable configuration of the CED, wherein the first discoverable configuration of the CED allows signals emitted by the first discoverable WD and the network node to be redirected to one another.

Item 36. The method according to Item 34 or Item 35, the method comprises:
redirecting, by the CED to the first discoverable WD, the first discoverable signal from the network node.

Item 37. The method according to any one of Items 34-36, wherein upon reception of the first discoverable signal by the first discoverable WD, the method comprises:
transmitting, by the first discoverable WD to the network node, a RACH signal.

Item 38. The method according to any one of Items 32-37, wherein the first discoverable WD receives the discovery signal from the first aiding WD, and wherein the method comprises redirecting the first response signal by the CED in accordance with the first predetermined spatial pattern.

Item 39. The method according to any one of Items 31-38, wherein, the method comprises:
redirecting, by the CED in a second configuration, a second set of discovery signals emitted by the plurality of aiding WDs according to a second predetermined spatial pattern; and wherein, when a second discoverable WD receives a second discovery signal:
transmitting, by the second discoverable WD, a second response signal.

Item 40. The method according to Item 39, wherein, in response to a reception of the second response signal by a second aiding WD, the method comprises:
transmitting, by the second aiding WD, a second identification signal, the second identification signal being indicative of an identification of the second discoverable WD.

Item 41. The method according to Item 40, wherein transmitting the second identification signal comprises transmitting the second identification signal by the second aiding WD to the network node.

Item 42. The method according to Item 41, wherein upon reception of the second identification signal by the network node, the method comprises:
transmitting, by the network node to the second discoverable WD, a second discoverable signal.

Item 43. The method according to Item 41 or Item 42, wherein upon reception of the second identification signal by the network node, the method comprises:
transmitting, by the network node to the CED, a second discoverable CED configuration message to configure the CED according to a second discoverable configuration of the CED, wherein the second discoverable configuration of the CED allows signals emitted by the second discoverable WD and the network node to be redirected to one another.

Item 44. The method according to Item 42 or Item 43, wherein the method comprises:
redirecting, by the CED, the second discoverable signal from the network node to the second discoverable WD.

Item 45. Method according to any one of Items 42-44, wherein upon reception of the second discoverable signal by the first discoverable WD, the method comprises:
transmitting, by the first discoverable WD to the network node, a RACH signal.

Item 46. Method according to any one of Items 40-45, wherein the second discoverable WD receives the second discovery signal from the second aiding WD, and wherein the method comprises:
redirecting, by the CED in in accordance with the second predetermined spatial pattern, the second response signal.

Item 47. Method according to any one of Items 39-46, the method comprising:
transmitting, by the network node to the CED, a second CED configuration message to configure the CED according the second configuration of the CED.

Item 48. Method according to any one of Items 29-47, wherein the identification signal is indicative of the predetermined spatial pattern.

Item 49. Method according to any one of Items 29-48, wherein the CED comprises an array of antennas, and wherein a change in the configuration of the CED comprises a change in phase delay of the arrays of antennas.

Item 50. Method according to any one of Items 29-49 when depending on Item 39, wherein the second predetermined spatial pattern covers a spatial region different from the first predetermined spatial pattern.

Item 51. The method according to Item 50, wherein, in each of a plurality of configurations of the CED, the method comprises:
redirecting, by the CED, a set of discovery signals emitted by the plurality of aiding WDs according to a predetermined spatial pattern, the plurality of configurations of the CED generating a plurality of predetermined spatial patterns;
wherein the plurality of spatial patterns covers an entire area of a predefined spatial region.

Item 52. Method according to any one of Items 29-41, wherein the discovery signals are SSB signals.

Item 53. A network node, wherein the network node is configured to:
transmit, to a CED, a CED configuration message to configure the CED according to the one or more configurations of the CED, the one or more configurations of the CED allowing the CED to redirect signals according to one or more spatial patterns, wherein the CED configuration message is indicative of a CED schedule for applying the one or more configurations of the CED; and
transmit, to a plurality of aiding WDs, a WD configuration message to configure the plurality of aiding WDs for contemporaneously sending discovery signals, wherein the WD configuration message is indicative of discovery resources for transmission of the discovery signals;
wherein the CED schedule and the discovery resources are aligned in a time domain, such that each respective discovery resource aligns with a respective configuration of the CED.

Item 54. The network node according to Item 53, wherein the network node is configured to:
receive, from at least one of the plurality of aiding WDs, a first identification signal, the first identification signal being indicative of an identification of a first discoverable WD.

Item 55. The network node according to Item 54, wherein the network node is configured to:
upon reception of the first identification signal by the network node, transmit a first discoverable signal to the first discoverable WD.

Item 56. The network node according to Item 54 or Item 55, wherein the network node is configured to:
upon reception of the first identification signal, transmit, to the CED, a first discoverable CED configuration message to configure the CED according to a first discoverable configuration of the CED, wherein the first discoverable configuration of the CED allows signals emitted by the first discoverable WD and the network node to be redirected to one another.

1. A communication system comprising:
a network node;
a plurality of aiding wireless devices (WDs); and
a coverage enhancing device (CED) configured to redirect signals according to a predetermined spatial pattern;
wherein the network node is configured to send, to the plurality of aiding WDs, a WD configuration message to configure the plurality of aiding WDs for contemporaneously sending discovery signals;
wherein, in a first configuration of the CED, the CED is configured to
redirect a first set of discovery signals emitted by the plurality of aiding WDs according to a first predetermined spatial pattern.

2. The communication system according to claim 1, wherein the network node is configured to send, to the CED, a CED configuration message to configure the CED according to the first configuration of the CED.

3. The communication system according to claim 1, wherein, when a first discoverable WD receives a first discovery signal:
the first discoverable WD is configured to emit a first response signal.

4. The communication system according to claim 3, wherein, in response to a reception of the first response signal by a first aiding WD of the plurality of aiding WDs, the first aiding WD is configured to send a first identification signal, the first identification signal being indicative of an identification of the first discoverable WD.

5. The communication system according to claim 4, wherein the first aiding WD is configured to send the first identification signal to the network node.

6. The communication system according to claim 5, wherein the network node is configured to, upon reception of the first identification signal, send a first discoverable signal 24 to the first discoverable WD.

7. The communication system according to claim 5, wherein the network node is configured to, upon reception of the first identification signal, send, to the CED, a first discoverable CED configuration message to configure the CED according to a first discoverable configuration of the CED, wherein the first discoverable configuration of the CED allows signals emitted by the first discoverable WD and the network node to be redirected to one another.

8. The communication system according to claim 6, wherein the CED is configured to redirect the first discoverable signal 24 from the network node to the first discoverable WD.

9. The communication system according to claim 6, wherein the first discoverable WD is configured to, upon reception of the first discoverable signal 24, send a RACH signal to the network node.

10. The communication system according to claim 4, wherein the first discoverable WD receives the first discovery signal from the first aiding WD, and wherein the first response signal is redirected by the CED in accordance with the first predetermined spatial pattern.

11. The communication system according to claim 3, wherein, in a second configuration of the CED, the CED is configured to redirect a second set of discovery signals emitted by the plurality of aiding WDs according to a second predetermined spatial pattern; and wherein, when a second discoverable WD receives a second discovery signal:
the second discoverable WD is configured to emit a second response signal.

12. The communication system according to claim 11, wherein, in response to a reception of the second response signal by a second aiding WD, the second aiding WD is configured to send a second identification signal, the second identification signal being indicative of an identification of the second discoverable WD.

13. The communication system according to claim 12, wherein the second aiding WD is configured to send the second identification signal to the network node.

14. The communication system according to claim 13, wherein the network node is configured to, upon reception of the second identification signal, send a second discoverable signal to the second discoverable WD.

15. The communication system according to claim 13, wherein the network node is configured to, upon reception of the second identification signal, send, to the CED, a second discoverable CED configuration message to configure the CED according to a second discoverable configuration of the CED, wherein the second discoverable configuration of the CED allows signals emitted by the second discoverable WD and the network node to be redirected to one another.

16. The communication system according to claim 14, wherein the CED is configured to redirect the second discoverable signal from the network node to the second discoverable WD.

17. The communication system according to claim 14, wherein the first discoverable WD is configured to, upon reception of the second discoverable signal, send a RACH signal to the network node.

18. The communication system according to claim 12, wherein the second discoverable WD receives the second discovery signal from the second aiding WD, and wherein the second response signal is redirected by the CED in accordance with the second predetermined spatial pattern.

19. The communication system according to claim 11, wherein the network node is configured to send, to the CED, a second CED configuration message to configure the CED according the second configuration of the CED.

20. A method of operating a network node, the method comprising:
transmitting, to a CED, a CED configuration message to configure the CED according to the one or more configurations of the CED, the one or more
configurations of the CED allowing the CED to redirect signals according to one or more spatial patterns, wherein the CED configuration message is indicative of a CED schedule for applying the one or more configurations of the CED; and
transmitting, to a plurality of aiding WDs, a WD configuration message to configure a plurality of aiding WDs for contemporaneously sending discovery signals, wherein the WD configuration message is indicative of discovery resources for transmission of the discovery signals;
wherein the CED schedule and the discovery resources are aligned in a time
domain, such that each respective discovery resource aligns with a respective configuration of the CED.
